(19) United States
(12) Patent Application Publication
(10) Pub. No.: US 2015/0199459 A1
(43) Pub. Date: Jul. 16, 2015

(54) Automated Design Enablers Methodology

(71) Applicant: DEP Autoline, Inc., Troy, MI (US)

(72) Inventors: Radhakrishnan Mariappasamy, Troy, MI (US); Radha Damodaran, Chennai (IN)

(73) Assignee: DEP Autoline, Inc.

(21) Appl. No.: 14/595,846

(22) Filed: Jan. 13, 2015

Related U.S. Application Data
(60) Provisional application No. 61/926,508, filed on Jan. 13, 2014.

(51) Int. Cl. G06F 17/50

(52) U.S. Cl. CPC G06F 17/5018

(57) ABSTRACT

A selection of one of the selectable members of a finite element model is received. Dimensions of the selected member are received. A number of desired instances of the selected member with the dimensions and a location of each of the instances are received. A revised finite element model of the mechanical system including the number of instances of the selected member is generated. The revised finite element model including the instances of the selected member at each respective locations are displayed.

### CROSS REFERENCE TO RELATED APPLICATIONS

I hereby claim benefit under Title 35, United States Code, Section 119(e) of U.S. provisional patent application Ser. No. 61/926,508 filed Jan. 13, 2014. The 61/926,508 application is currently pending. The 61/926,508 application is hereby incorporated by reference into this application.

### BACKGROUND OF THE INVENTION

Engineering design work can be a time-intensive process that requires a great deal of time and integration between different systems related to the design process. For example, if a part of a mechanical system needs to be designed (or redesigned), the design process often requires that an engineer create a geometric design for the part, identify any necessary functions related to the operation of the part, and then figure out what material properties would be applicable to the part. The engineer would then have to figure out how to implement this part into the mechanical system. This process would then have to repeated for each new part to be designed, even if it were identical to an existing part. This is a labor and time intensive process that requires coordination and communication amongst varying design systems and additional knowledge and research by the engineer.

### BRIEF SUMMARY OF THE INVENTION

The invention generally relates to an automated design system. A selection of one of the selectable members of a finite element model is received. Dimensions of the selected member are received. A number of desired instances of the selected member with the dimensions and a location of each of the instances are received. A revised finite element model of the mechanical system including the number of instances of the selected member is generated. The revised finite element model including the instances of the selected member at each of the respective locations are displayed.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram of an automated design system (ADS), according to an example embodiment.

FIG. 2 is an example embodiment of the feature properties of ADS.

FIG. 3 is an example of creating an enhancement to a selectable member, according to an embodiment.

FIG. 4 is an example of creating a new selectable member, according to an embodiment.

FIG. 5 is an example of adjusting a penetration of a selectable member, according to an embodiment.

FIG. 6 is an example of specifying the connections of a selectable member, according to an embodiment.

FIG. 7 is an example of specifying the instances of a selectable member, according to an embodiment.

FIGS. 8A-8D are an example of modifying a selectable member, according to an embodiment.

FIG. 9 is a flow chart of an example processing as performed by the ADS, according to an embodiment.

### DETAILED DESCRIPTION OF THE INVENTION

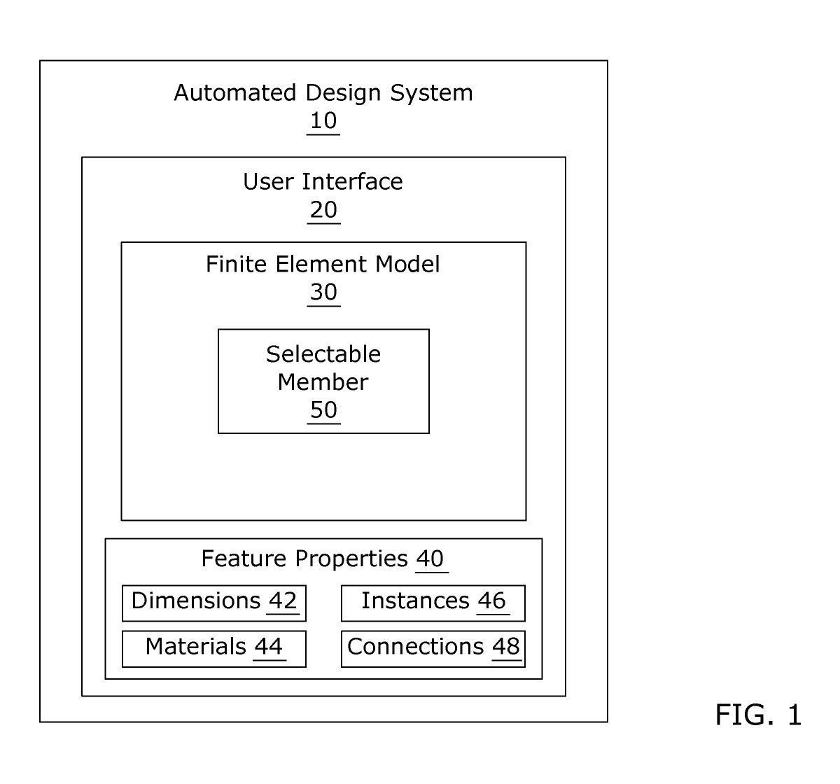

FIG. 1 is a block diagram of an automated design system (ADS) 10, according to an example embodiment. ADS 10 enables designers to quickly design and redesign parts or portions (e.g., members 50) of engineering devices, vehicles, or other systems using a simple user interface 20. ADS 10 provides integrated design system that prompts the user for any necessary information required in the design or redesign of a selectable member 50.

User interface 20 of ADS 10 enables a designer, engineer, or other user to select a portion (selectable member 50) of a finite element model (FEM) 30 to design or re-design and provide enter any necessary feature properties 40 associated with the selectable member 50. After prompting the user for any necessary information related to the design, ADS 10 may provide, via user interface 20, a revised FEM 30 including the new and/or re-designed selectable member 50 with provided feature properties 40. The designer may then make any necessary adjustments, copies, or prepare the FEM 30 for manufacture.

ADS 10 may aid in the design of mechanical systems, such as automotive, aerospace, building, naval, heavy equipment, oil and gas, construction, or other systems. These systems may be very simple or complex and include many moving parts that are integrated or otherwise connected to each other and are necessary for proper functioning of the system. For example, a door of a truck may be a portion of an entire automotive system, but the door itself may be made of various members that are connected to one another or otherwise work together. In another embodiment, ADS 10 may aid in the design of other systems, such as plumbing or electrical systems.

User interface 20 may display a previously designed or existing mechanical system as FEM 30. FEM 30 may include a number of connected or integrated components (members) of the system. In continuing the example above, in a first embodiment, FEM 30 may be the entire truck, with the door being a selectable member 50 of the truck system.

In a second embodiment, the FEM 30 may be the door, while the door has one or more selectable members 50 (such as the handles and locks).

In an embodiment, ADS 10 may import an existing or designed FEM 30 of a mechanical system. User interface 20 may then allow a user or designer to select a member 50 of the FEM 30 to design or redesign. Selectable member 50 may be any part or portion of FEM 30 that may have its own feature properties 40. As used herein, the terms component, member, portion, and part are used interchangeably.

Selectable member 50 may be any part of FEM 30. For example, rather than being an individual part of FEM 30, selectable member 50 may be a region of FEM 30 that is to be enhanced. Example enhancements of selectable members 50 include, but are not limited to a bulkhead, dart, doubler (reinforcement), punch hole, shell ribs, tailor welded blank, tailor rolled blank. A bulkhead may be a member 50 that connects inner and outer channels of a closed section of the mechanical system. A dart may be a structural depression that increase a stiffness of a selected member 50. A doubler may be a reinforcement added to a region of weakness in a design. A selected member 50 may be hole punched to reduce a weight of the selected member. A shell rib may automatically stiffen a member 50. In other embodiments, ADS 10 may allow for selectable member 50 may to be selected for extension, contraction, movement, or replication.

Feature properties 40 may include any characteristics relevant to the design, redesign, or enhancement of a selectable member 50. Example feature properties include dimensions 42, materials 44, penetration 45, instances 46 and connections 48. Dimensions 42 may include the physical dimensions of the selectable member 50, such as shape, length, width, depth, circumference, or any other dimension.

Materials 44 may include any characteristics about the material 44 of selectable member 50 relevant to the design of selectable member 50 and/or FEM 30. Materials 44 may include an indication of which material is being used such as wood, rubber, steel, etc. Materials 44 may also include additional specifications such as thickness, brand, or special characteristics of the material used 44 (e.g., such as tempered steel). In an embodiment, ADS 10 may include a database of how materials 44 react to a stimulus. For example, ADS 10 may include a default elasticity of rubber, but a designer may provide a different elasticity as applicable to selectable member 50. Or, for example, ADS 10 may account for the varying elasticity of several different popular rubber manufacturers.

Instances 46 may be indication of how many selectable members 50 are being designed or redesigned. For example, FEM 30 may include a single part or member 50 used throughout the design in multiple locations. ADS 10 may allow a designer to redesign each similar part or selectable member 50 simultaneously and/or create copies of a newly designed selectable member 50 to be used in multiple locations on FEM 30.

Connections 48 may include information about connections to other parts, portions, FEMs 30, or selectable members 50. Connections 48 may include, for example, how selectable member 50 is connected to another part (e.g., welded, glued, etc.), and/or to which parts selectable member 50 is connected.

ADS 10 provides an engineer or other user a single easy-to-use interface 20 for a single, integrated design system. ADS 10 may reduce the design time required to design new parts and/or enhance existing mechanical or other systems. With a simple point-and-click interface 20, ADS 10 may prompt a user for any necessary information regarding a member 50 design and model the design easily and in real-time for the user and in only a fraction of the time that would otherwise be required for the designer to perform a similar process without the use of ADS 10.

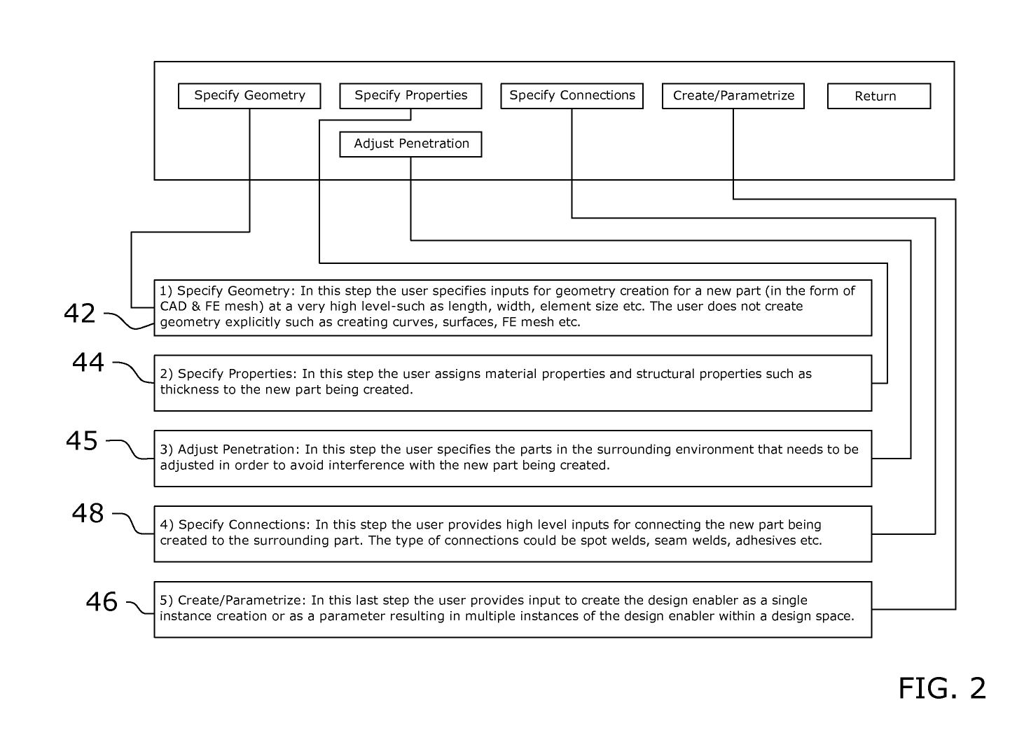

FIG. 2 is an example embodiment of the feature properties 40 of ADS 10. Feature properties 40 may include any specifications or features required by ADS 10 related to the design of a selectable member 50. In an embodiment, different members 50 may have different feature properties 40. ADS 10 may prompt or otherwise notify a user as to which features 40 are required, optional, or non-applicable for a selectable member 50.

ADS 10 may allow a user to specify geometry 42. Geometry 42 may include the shape and/or dimensions of the selectable member 50 being designed. For example, geometry may allow a user to specify the shape of a circle, with a specified circumference.

A user may specify properties 44. Properties 44 may include any material and/or structural properties relevant to the design of a selected (selectable) member 50. For example, structural properties 44 may include the thickness of a member 50.

A user may adjust penetration 45. Penetration 45 may be an indication or specification as to which parts may need to be adjusted to avoid interference with the new part being created or designed.

A user may specify connections 48. Connections 48 may indicate whether, where, and the type of connection that may be necessary for selectable member 50. In continuing the example above, connections 48 may indicate that the new pipe needs to be welded to the pipe with the hole of a particular size at a specific location, and type of weld to be used. In other embodiments, connections 48 may include nailing, stapling, gluing, or other manners of connections, including no connection at all.

A user may specify the parameters or instances 46. A user may indicate how many copies of the newly designed part or member 50 are to be created, and the location of those parts. For example, a user may specify three copies of a shaft are created and placed 50 cm from each other beginning a location indicated on FEM 30.

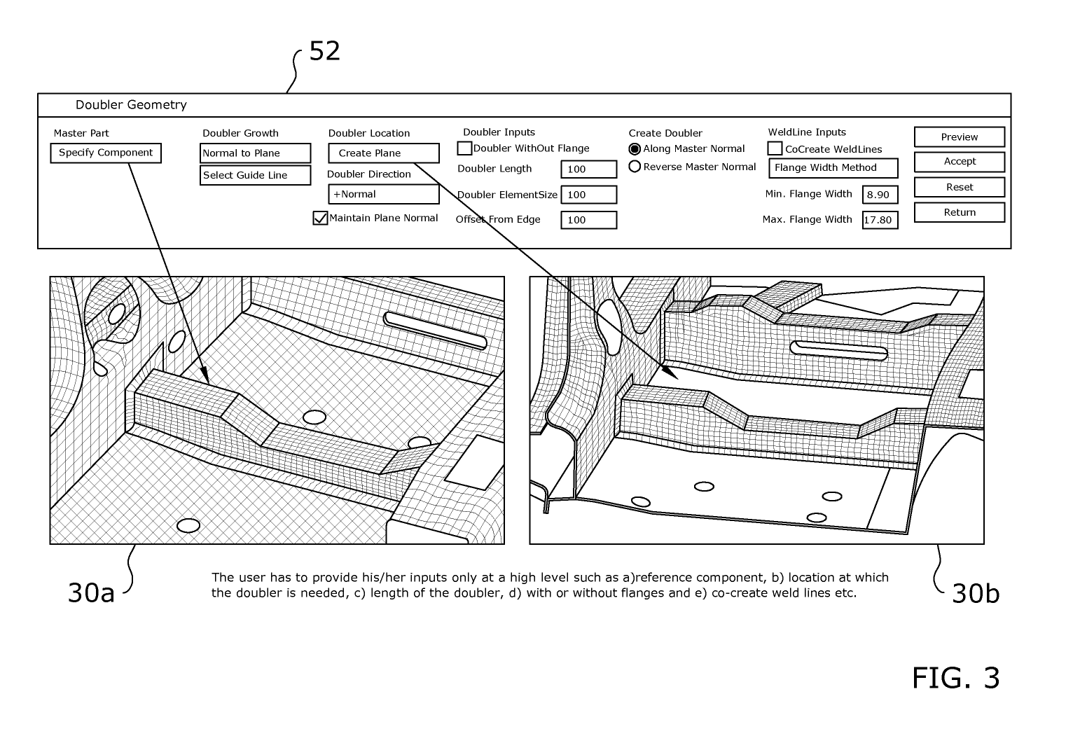

FIG. 3 is an example of creating an enhancement to a selectable member 50, according to an embodiment. In the example of FIG. 3, the selectable member 50 may be a selectable region of FEM 30 selected by the user for reinforcement with a doubler. In another embodiment, the doubler itself may be the selectable member 50. Though the example of a doubler is provided, it is understood that other selectable members/enhancements 50 widely used in mechanical systems may be used as well.

ADS 10 may include built-in parameters specific to the creation of a doubler, as shown in box 52. A user may first select a master part or region, as shown by the arrow in FEM 30a. The user may then select a location of the doubler, as shown in FEM 30b. The user may also provide any feature properties 40 necessary, which may be indicated by box 52. Example feature properties 40 include a length, whether or not the doubler has flanges, and any weld lines.

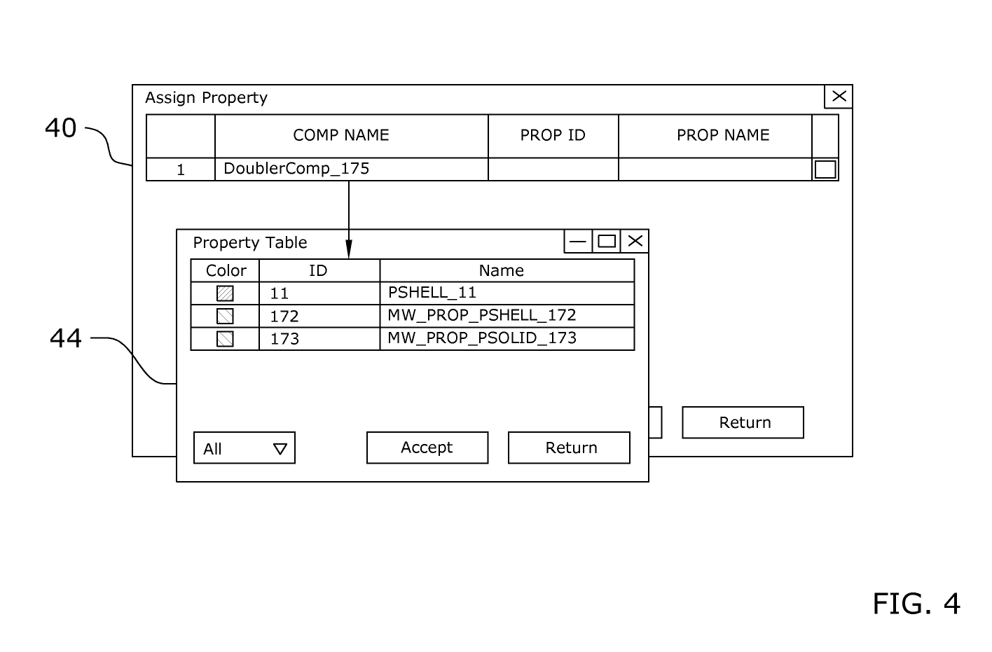

FIG. 4 is an example of creating a new selectable member 50, according to an embodiment. In the example of FIG. 4, a user may select which properties to assign to the new selectable member 40 as shown in box 40. The user may select to assign material properties as shown in box 44. The material properties 44 may include a thickness and material definition. In an embodiment, each material may be associated with a corresponding color in FEM 30. Then, for example, from looking at FEM 30, a user may be able to determine which materials are used for which part(s) or members 50.

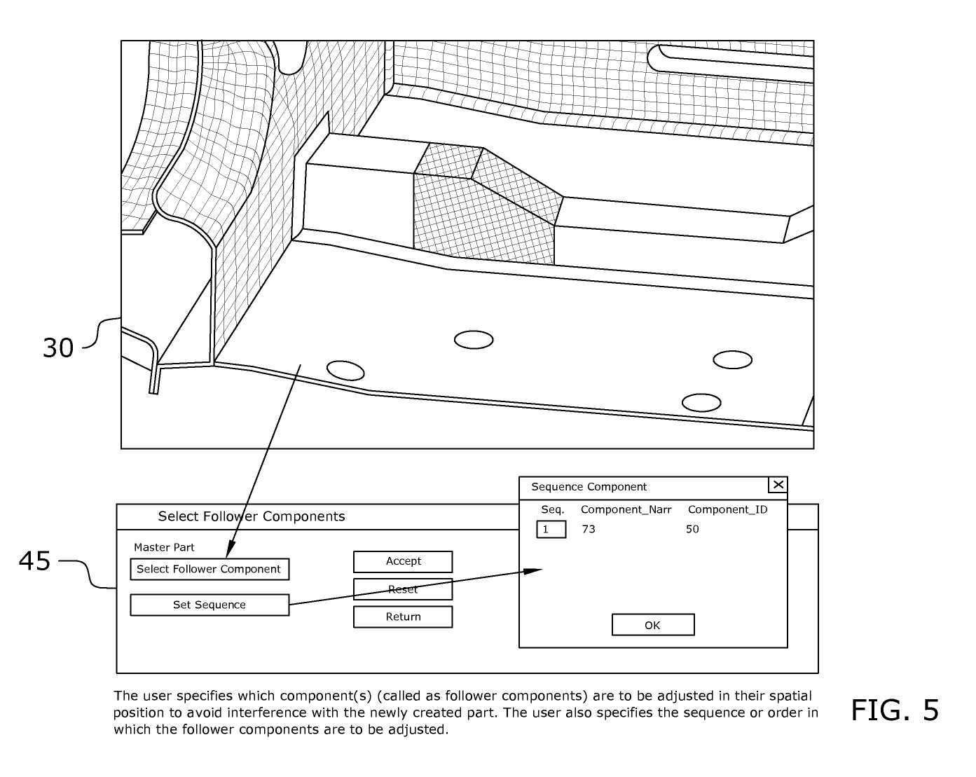

FIG. 5 is an example of adjusting a penetration 45 of a selectable member 50, according to an embodiment. A user may create a new member 50 to be included in FEM 30. However, the addition of the new member 50 may require that one or more existing members 50 need to be adjusted. Penetration 45 may be an indication as to how existing members or parts may be affected or need to be adjusted with the addition of a new member 50.

As shown in the example of FIG. 5, a user may select which component(s) 50 need adjustment, how they are to be adjusted, and/or the order or sequence of adjustment. In an embodiment, ADS 10 may indicate an interference with one or more components 50 that need to be adjusted with the addition of a new member 50.

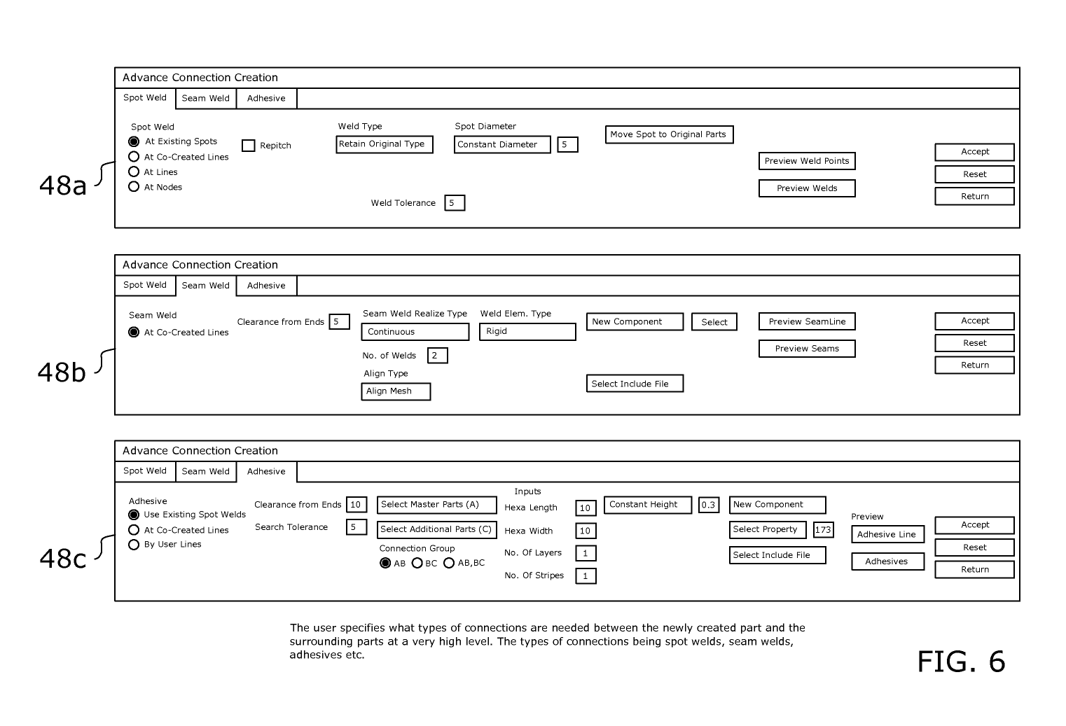

FIG. 6 is an example of specifying the connections 48 of a selectable member 50, according to an embodiment. In the example of FIG. 6, a user may specify any of three types of connections, a spot weld 48a, a seam weld 48b, or an adhesive 48c. Each connection type may have its own properties that may be specified by a user as shown. In other embodiments, ADS 10 may provide for different types of connections other than those shown. In an embodiment, the provided connections 48 may be dependent upon the materials 44 used.

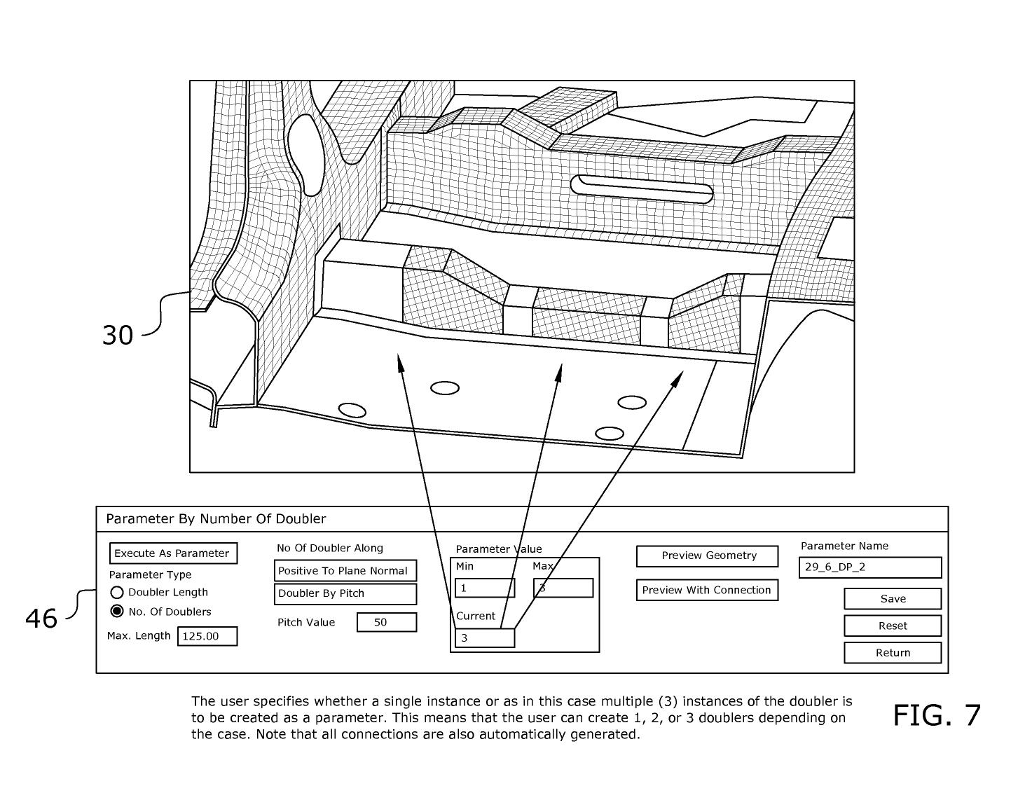

FIG. 7 is an example of specifying the instances 46 of a selectable member 50, according to an embodiment. A user may indicate the number of instances of a new member 50 to be created in FEM 30, and the location of the new members(s) as indicated by the arrows. Or, for example, the user may indicate a location of a first component and a distance or pitch value between the components or members. Additionally, a user may specify a name for each instance or class/type of component. For example, a particular hinge component may be referred to as “Hinge A” for each instance of the hinge, or each instance may have its own name (e.g., which may be associated with its instance name or other variable).

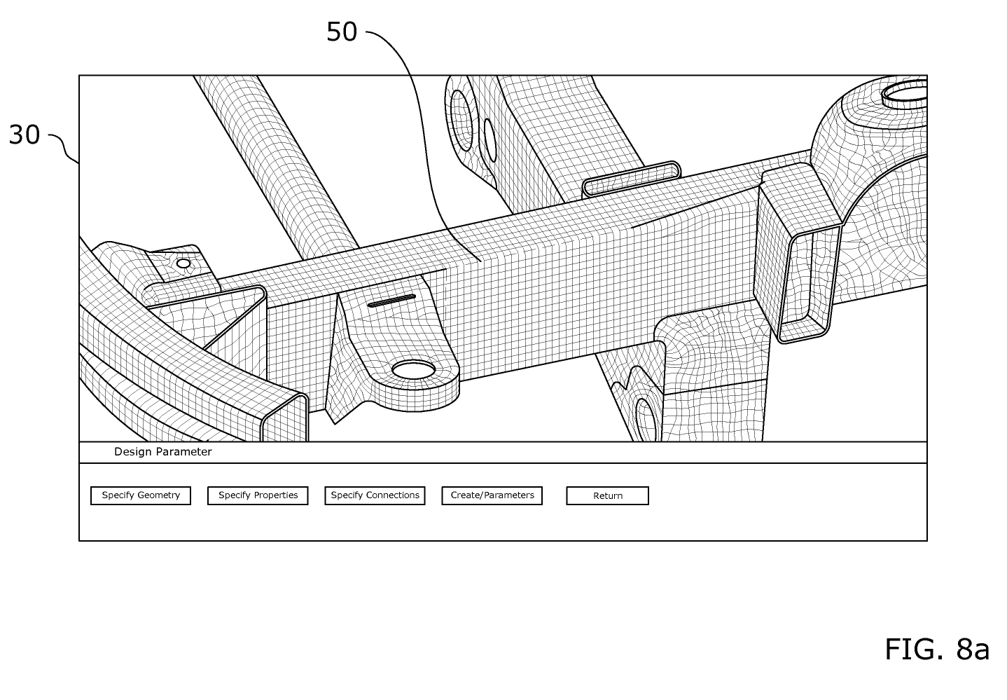

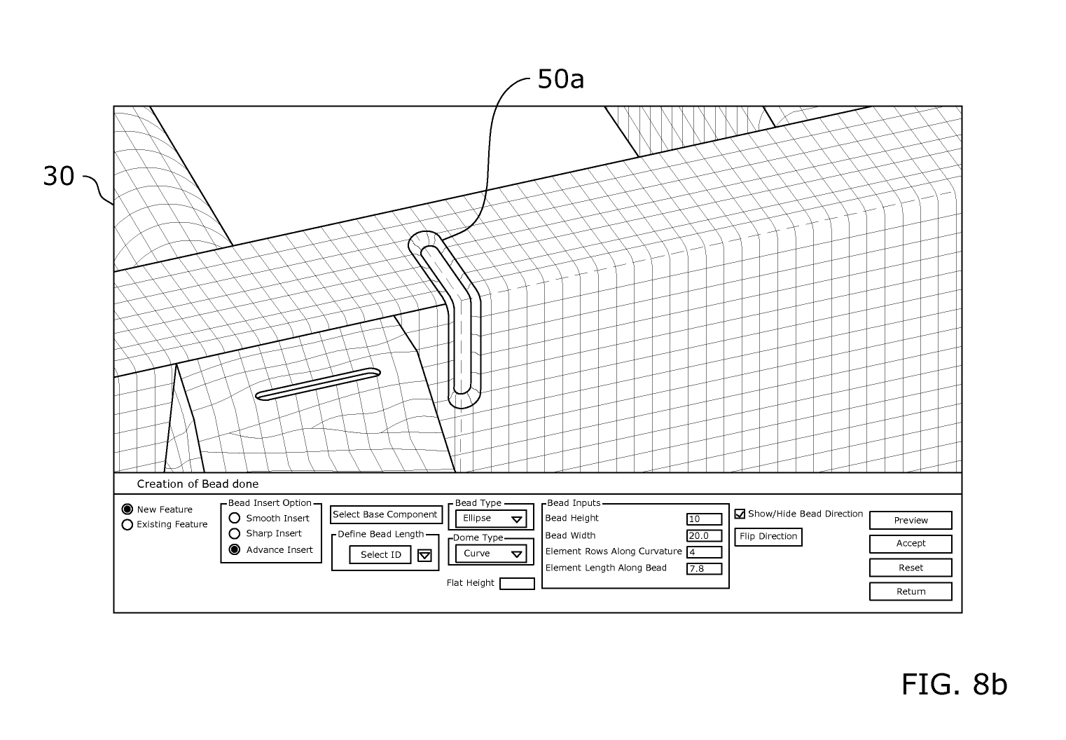

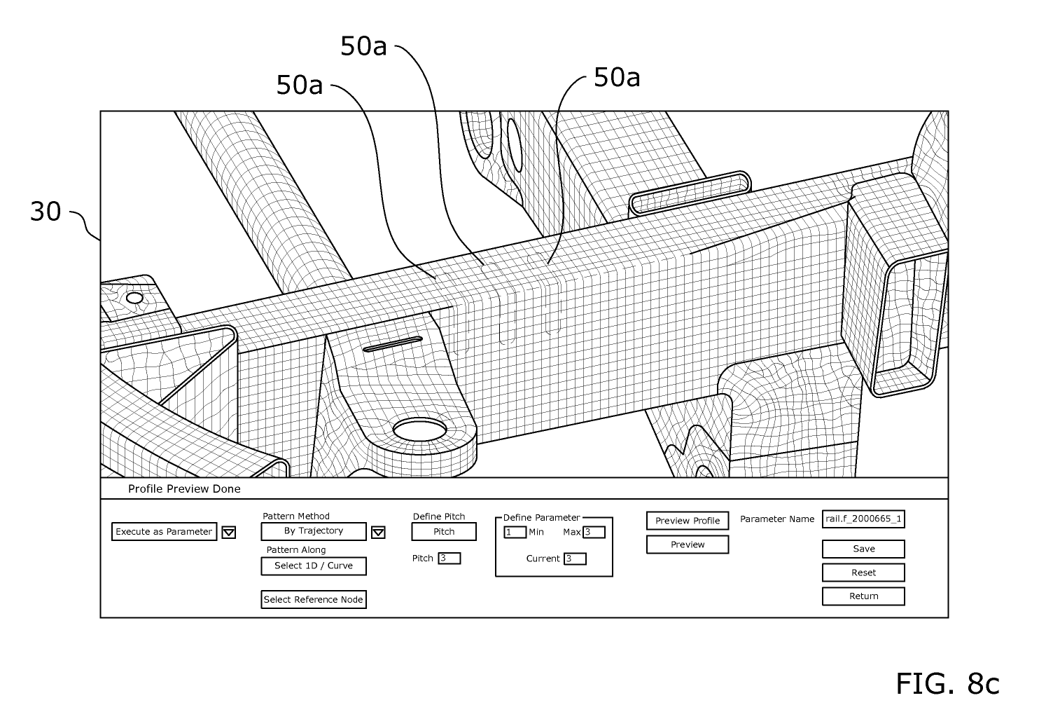

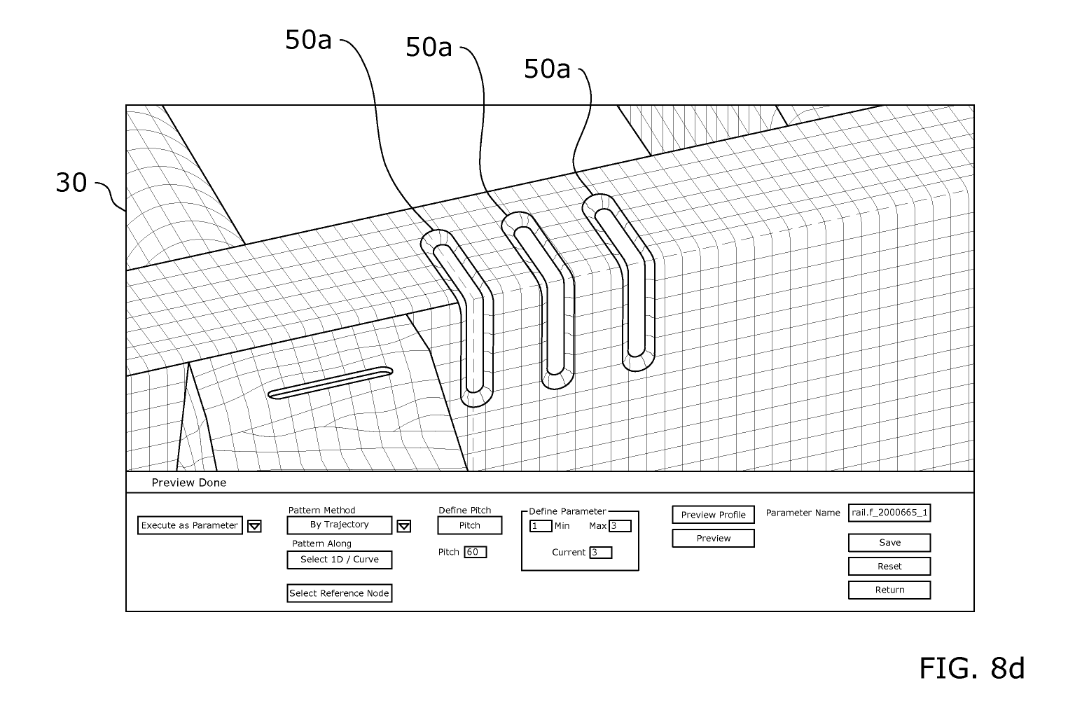

FIGS. 8A-8D are an example of modifying an existing selectable member 50, according to an embodiment. In FIG. 8A, the bumper of a vehicle, such a truck, may be selected as the selectable component 50 of the mechanical system of a truck 30. The selected region of the bumper is shown next to the trailer hitch in FIG. 8A. In FIG. 8B, a crush initiator 50A may be a new component or feature added to or integrated with the selected bumper (member). The crush initiator 50A may cause or influence how the bumper reacts to an impact, to ensure the bumper member 50 absorbs energy in a particular way.

Upon specifying feature properties 40 of the crush initiator 50A, ADS 10 may allow a user to create and locate multiple instances of the new component 50A as shown in FIG. 8C. A user may indicate via user interface 20 where the various crush initiators 50A are to be placed along the selected member 50. In the embodiment shown, each crush initiator 50A may include identical features. In another embodiment, a user may modify the features of one or more of the crush initiators 50A to be different from the other copies of the crush initiator 50A. FIG. 8D shows an example of the selected truck bumper with the three newly added crush initiators 50A as they would appear in the mechanical system if the bumper were to be manufactured as designed.

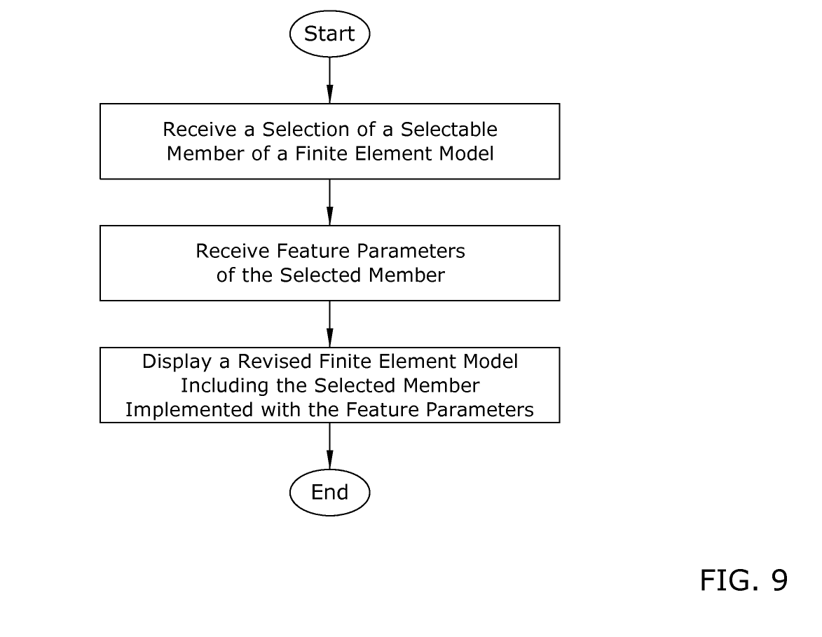

FIG. 9 is a flow chart of an example processing as performed by the ADS 10, according to an embodiment. ADS 10 may receive a selection of a selectable component 50 that already exists within FEM 30 that is going to be redesigned, enhanced, moved, or otherwise modified. In an embodiment, ADS 10 may receive a selection by a user to create a new component not currently part of or displayed in FEM 30.

ADS 10 may receive feature parameters 40 of the selected component 50. The feature parameters 40 may include any number of different parameters such as dimensions, materials, connections, and instances or copies. In an embodiment, ADS 10 may prompt the user for whichever information is necessary to design or redesign the selected component based on which type of component was selected.

ADS 10 may automate the processing of the received parameters 40 within a single integrated system. This single system integration allows a user to save time rather than having to manually switch between different systems in order to design system components or members. ADS 10 may then display a revised finite element model including the new or redesigned members on user interface 20.

ADS 10 may be implemented on a conventional computer, which may be modified to suit the processing requirements of the ADS 10 as described herein. A conventional computer preferably includes a display screen (or monitor), a printer, a hard disk drive, a network interface, and a keyboard. A conventional computer also includes a microprocessor, a memory bus, random access memory (RAM), read only memory (ROM), a peripheral bus, and a keyboard controller. The microprocessor is a general-purpose digital processor that controls the operation of the computer. The microprocessor can be a single-chip processor or implemented with multiple components. Using instructions retrieved from memory, the microprocessor controls the reception and manipulations of input data and the output and display of data on output devices. The memory bus is utilized by the microprocessor to access the RAM and the ROM. RAM is used by microprocessor as a general storage area and as scratch-pad memory, and can also be used to store input data and processed data. ROM can be used to store instructions or program code followed by microprocessor as well as other data. A peripheral bus is used to access the input, output and storage devices used by the computer. In the described embodiments, these devices include a display screen, a printer device, a hard disk drive, and a network interface. A keyboard controller is used to receive input from the keyboard and send decoded symbols for each pressed key to microprocessor over bus. The keyboard is used by a user to input commands and other instructions to the computer system. Other types of user input devices can also be used in conjunction with the present invention. For example, pointing devices such as a computer mouse, a track ball, a stylus, or a tablet to manipulate a pointer on a screen of the computer system. The display screen is an output device that displays images of data provided by the microprocessor via the peripheral bus or provided by other components in the computer. The printer device when operating as a printer provides an image on a sheet of paper or a similar surface. The hard disk drive can be utilized to store various types of data. The microprocessor together with an operating system operate to execute computer code and produce and use data. The computer code and data may reside on RAM, ROM, or hard disk drive. The computer code and data can also reside on a removable program medium and loaded or installed onto computer system when needed. Removable program mediums include, for example, CD-ROM, PC-CARD, USB drives, floppy disk and magnetic tape. The network interface circuit is utilized to send and receive data over a network connected to other computer systems. An interface card or similar device and appropriate software implemented by microprocessor can be utilized to connect the computer system to an existing network and transfer data according to standard protocols.

The data structures and code described in this detailed description are typically stored on a computer readable storage medium, which may be any device or medium that can store code and/or data for use by a computer system. For example, in an embodiment, ADS 10 may be implemented through coding (such as C++ or Fortran) as stored in a memory and implemented or executed by one or more processors. This includes, but is not limited to, magnetic and optical storage devices such as disk drives, magnetic tape, CDs (compact discs), DVDs (digital video discs), and computer instruction signals embodied in a transmission medium (with or without a carrier wave upon which the signals are modulated). For example, the transmission medium may include a telecommunications network, such as the Internet.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention. These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks. Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

The present invention may be embodied in other specific forms without departing from the spirit or essential attributes thereof, and it is therefore desired that the present embodiment be considered in all respects as illustrative and not restrictive. Many modifications and other embodiments of the invention will come to mind to one skilled in the art to which this invention pertains and having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although methods and materials similar to or equivalent to those described herein can be used in the practice or testing of the present invention, suitable methods and materials are described above. Thus, the present invention is not intended to be limited to the embodiments shown, but is to be accorded the widest scope consistent with the principles and features disclosed herein.

The invention as claimed is:

1. A method comprising:
receiving, by a processor, a finite element model of a mechanical system, wherein the finite element model includes one or more selectable members of the mechanical system;
displaying at least a portion of the finite element model;
receiving, from a user, a selection of one of the selectable members of the mechanical system from the displayed finite element model;
receiving dimensions of the selected member;
receiving a number of desired instances of the selected member with the dimensions and a location of each of the instances;
generating, by the processor, a revised finite element model of the mechanical system including the number of instances of the selected member;
displaying, by the processor, the revised finite element model including the instances of the selected member at each respective locations.

2. The method of claim 1, wherein the number of desired instances is two or more instances

3. The method of claim 1, further comprising:
receiving material properties corresponding to a material associated with a manufacture of the selected member.

4. The method of claim 1, further comprising:
receiving connection properties corresponding to a connection of the selected member to one or more other members of the finite element model.

5. The method of claim 1, wherein the selected member is a new component not displayed in the finite element model.

6. The method of claim 1, wherein the selected member is a bulkhead that connects inner and outer channels of a closed section of the mechanical system.

7. The method of claim 1, wherein the selected member is a dart, wherein the dart comprises a structural depression that increase a stiffness of a selected member of the mechanical system.

8. The method of claim 1, wherein the selected member is a hole punched into a selected member of the mechanical system, wherein the hole reduces a weight of the selected member.

9. The method of claim 1, wherein the selected member is an extension of the selected member of the mechanical system.

10. The method of claim 1, wherein the selected configurable feature is a contraction of the selected member of the mechanical system.

11. The method of claim 1, wherein the selected member is a shell rib, wherein the shell rib that increase a stiffness of a selected member of the mechanical system without a structural depression.

12. The method of claim 1, wherein the selected member comprises a movement of the selected member of the mechanical system from a first location to a second location.

13. A system comprising: one or more processors coupled to a non-transitory memory, that when executed perform the following:
receive a selection of one of the selectable members of a finite element model;
receive dimensions of the selected member;
receive a number of desired instances of the selected member with the dimensions and a location of each of the instances;
generate a revised finite element model of the mechanical system including the number of instances of the selected member; and
display the revised finite element model including the instances of the selected member at each respective locations.

14. The system of claim 13, wherein the number of desired instances is two or more instances

15. The system of claim 13, wherein the processors when executed further:
receive material properties corresponding to a material associated with a manufacture of the selected member.

16. The system of claim 13, wherein the processors when executed further receive connection properties corresponding to a connection of the selected member to one or more other members of the finite element model.

17. The system of claim 13, wherein the selected member is a new component not displayed in the finite element model.

18. A computer program product tangibly embodied on a non-transitory computer readable medium that when executed by one or more processors, causes the one or more processors to:
receive a selection of one of the selectable members of a finite element model;
receive dimensions of the selected member;
receive a number of desired instances of the selected member with the dimensions and a location of each of the instances;
generate a revised finite element model of the mechanical system including the number of instances of the selected member; and
display the revised finite element model including the instances of the selected member at each respective locations.

19. The computer program product of claim 18, wherein the number of desired instances is two or more instances

20. The computer program product of claim 18, wherein the selected member is a new component not displayed in the finite element model.
